(19) United States
(12) Patent Application Publication
(10) Pub. No.: US 2021/0094526 A1
(43) Pub. Date: Apr. 1, 2021

(54) Apparatus for Diagnosing a Failure in a Negative Pressure Sensor, Method for Diagnosing a Failure in a Negative Pressure Sensor, and Brake Apparatus

(71) Applicant: Hitachi Automotive Systems, Ltd., Hitachinaka-shi, Ibaraki (JP)

(72) Inventor: Naoshi YAMAGUCHI, Yamato-shi, Kanagawa (JP)

(21) Appl. No.: 16/464,629

(22) PCT Filed: Sep. 11, 2017
(86) PCT No.: PCT/JP2017/032602

§ 371 Date: May 28, 2019

(30) Foreign Application Priority Data
Nov. 29, 2016 (JP) 2016-231715

(51) Int. Cl. B60T 17/22; G07C 5/08; B60T 13/14; B60Q 9/00

(52) U.S. Cl. CPC B60T 17/221; G07C 5/0808; G07C 5/0816; B60T 2220/04; B60Q 9/00; B60T 2270/88; B60T 13/145

(57) ABSTRACT

The present invention provides an apparatus for diagnosing a failure in a negative pressure sensor, a method for diagnosing a failure in a negative pressure sensor, and a brake apparatus capable of preventing or cutting down a reduction in a frequency at which an abnormality in the negative pressure sensor is diagnosed. The apparatus for diagnosing the failure in the negative pressure sensor includes a change amount monitoring portion configured to monitor a change amount of a detection signal of the negative pressure sensor when a brake pedal is returned after being pressed, and an abnormality determination portion configured to determine that the negative pressure sensor is abnormal if the change amount is a predetermined change amount or smaller.

### TECHNICAL FIELD

The present invention relates to an apparatus for diagnosing a failure in a negative pressure sensor, a method for diagnosing a failure in a negative pressure sensor, and a brake apparatus.

### BACKGROUND ART

PTL 1 discloses a technique that determines that a negative pressure sensor is abnormal when a detection signal of the negative pressure sensor, which detects a pressure in a negative pressure chamber in a brake booster, falls outside a predetermined range with a master cylinder hydraulic pressure reaching an assist limit on the brake booster.

### CITATION LIST

### Patent Literature

[PTL 1] Japanese Patent No. 5302636

### SUMMARY OF INVENTION

### Technical Problem

However, the above-described conventional technique has such a problem that a brake operation enough for the master cylinder hydraulic pressure to reach the assist limit on the brake booster is necessary to trigger the determination about the abnormality in the negative-pressure sensor, as a result of which the abnormality in the negative pressure is little frequently diagnosed.

An object of the present invention is to provide an apparatus for diagnosing a failure in a negative pressure sensor, a method for diagnosing a failure in a negative pressure sensor, and a brake apparatus capable of preventing or cutting down the reduction in the frequency at which the abnormality in the negative pressure sensor is diagnosed.

### Solution to Problem

According to one aspect of the present invention, an apparatus for diagnosing a failure in a negative pressure sensor determines that the negative pressure sensor is abnormal if a change amount of a detection signal of the negative pressure sensor is a predetermined change amount or smaller when a brake pedal is returned after being pressed.

Therefore, the apparatus for diagnosing the failure in the negative pressure sensor can prevent or cut down the reduction in the frequency at which the abnormality of the negative pressure sensor is diagnosed.

### BRIEF DESCRIPTION OF DRAWINGS

FIG. 1 illustrates a system configuration indicating a braking/driving system of a vehicle with a brake apparatus according to a first embodiment employed therefor.

FIG. 2 illustrates a hydraulic circuit of the brake apparatus according to the first embodiment.

FIG. 3 is a vertical cross-sectional view of a brake booster BB.

FIG. 4 is a schematic view of main portions of a negative pressure sensor 25.

FIG. 5 is a schematic view of main portions indicating an example of a stuck failure in the negative pressure sensor 25.

FIG. 6 is a flowchart illustrating a flow of processing for diagnosing a failure in the negative pressure sensor by a failure diagnosis apparatus 27 according to the first embodiment.

FIG. 7 is a timing chart indicating a function of diagnosing the failure in the negative pressure sensor according to the first embodiment.

### DESCRIPTION OF EMBODIMENTS

### First Embodiment

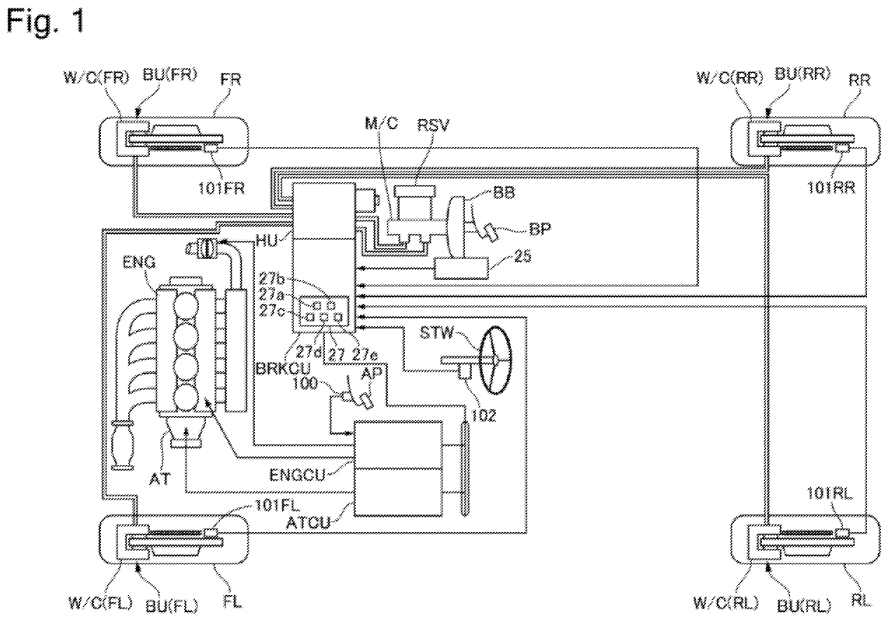

FIG. 1 illustrates a system configuration indicating a braking/driving system of a vehicle with a brake apparatus according to a first embodiment mounted thereon.

The brake apparatus according to the first embodiment is employed for an engine vehicle. The brake apparatus applies a frictional braking force with use of a hydraulic pressure to each of wheels (a front left wheel FL, a front right wheel FR, a rear left wheel RL, and a rear right wheel RR) of the vehicle. A brake actuation unit BU is provided for each of the wheels FR to RR. The brake actuation unit BU is a braking force generation portion including a wheel cylinder W/C. The brake actuation unit BU is, for example, a disk-type brake, and includes a caliper (a hydraulic brake caliper). The caliper includes a brake disk and brake pads. The brake disk is a brake rotor that rotates integrally with a tire. The brake pads are disposed with predetermined clearances generated from the brake disk, and contact the brake disk by being moved by the hydraulic pressure in the wheel cylinder W/C. The frictional braking force is generated by the contacts of the brake pads to the brake disk.

An engine ENG is coupled with each of the front left and right wheels FL and FR via an automatic transmission AT and a not-illustrated differential gear and a front drive shaft. The engine ENG applies a driving force to each of the front left and right wheels FL and FR based on an instruction from an engine control unit ENGCU. The engine control unit ENGCU controls a fuel injection amount and an ignition timing of the engine ENG based on an operation state such as the number of rotations of the engine, an amount of intake air, a temperature of cooling water, and a position of an accelerator pedal AP (an accelerator position) that is detected by an accelerator position sensor 100.

The automatic transmission AT is a stepped transmission, and switches a gear position based on an instruction from an AT control unit ATCU. The AT control unit ATCU searches for an optimum gear position based on a position at which a driving point determined from the accelerator position and a vehicle speed is located on a shift map, and controls an engagement capacity of each engagement element in the automatic transmission AT so as to be able to acquire the searched gear position, for example, when the vehicle is running with a D range selected. A shift-up line and a shift-down line are set according to the driving point on the shift map.

A brake control unit (a control unit) BRKCU transmits an instruction to a hydraulic unit HU based on a master cylinder hydraulic pressure detected by a master cylinder hydraulic pressure sensor 103, each of wheel speeds detected by respective wheel speed sensors 101FL, 101FR, 101RL, and 101RR provided for the individual wheels FL to RR, a steering angle of a steering wheel STW that is detected by a steering angle sensor 102, and other vehicle states (a longitudinal G, a lateral G, and a yaw rate). The hydraulic unit HU increases/reduces or maintains the wheel cylinder hydraulic pressure in each of the brake actuation units BU according to the instruction from the brake control unit BRKCU.

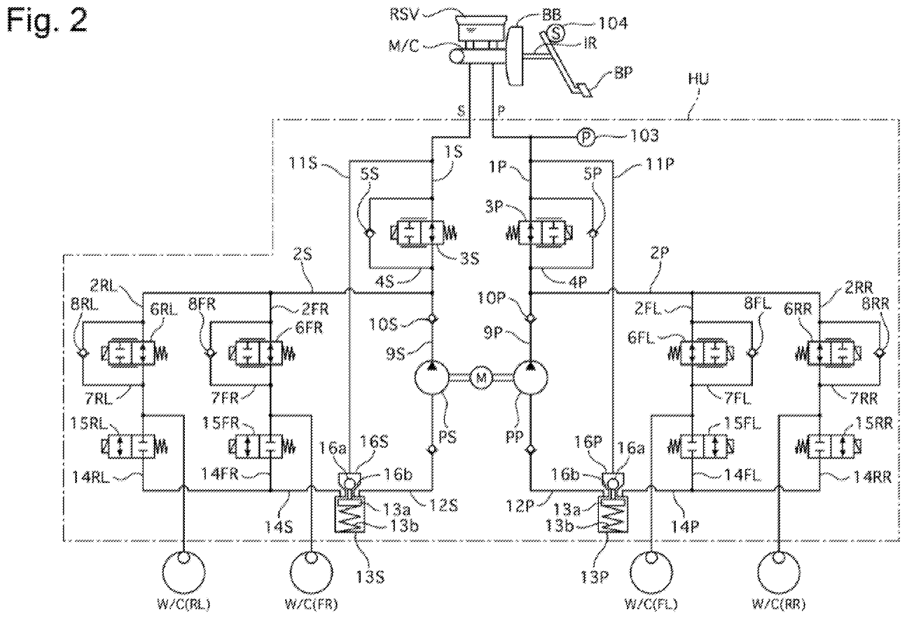

FIG. 2 illustrates a hydraulic circuit of the brake apparatus according to the first embodiment.

The brake apparatus according to the first embodiment includes two brake pipe systems (a primary P system and a secondary S system). A brake pipe configuration is an X-split pipe configuration. Hereinafter, when a component corresponding to the P system and a component corresponding to the S system are distinguished from each other, indexes P and S will be added at the ends of the respective reference numerals. When the component corresponding to the P system and the component corresponding to the S system are not distinguished from each other, the indexes P and S will be omitted. Further, when a component corresponding to the front left wheel FL, a component corresponding to the front right wheel FR, a component corresponding to the rear left wheel RL, and a component corresponding to the rear right wheel RR are distinguished from one another, indexes FL, FR, RL, and RR will be added at the ends of the respective reference numerals. When the component corresponding to the front left wheel FL, the component corresponding to the front right wheel FR, the component corresponding to the rear left wheel RL, and the component corresponding to the rear right wheel RR are not distinguished from one another, the indexes FL, FR, RL, and RR will be omitted.

A brake pedal BP is connected to a master cylinder M/C via an input rod IR. A pedal pressing force input to the brake pedal BP is boosted by a brake booster BB. The brake booster BB boosts the brake operation force by utilizing an intake negative pressure generated by the engine. A stroke sensor 104 is provided for the brake pedal BP. The stroke sensor 104 detects a displacement amount of the brake pedal BP (a pedal stroke). The master cylinder M/C is replenished with brake fluid from a reservoir tank RSV, and generates the master cylinder hydraulic pressure according to the operation performed on the brake pedal BP. The master cylinder M/C and the wheel cylinders W/C are connected to each other via the hydraulic unit HU. The wheel cylinder W/C (FL) for the front left wheel FL and the wheel cylinder W/C (RR) for the rear right wheel RR are connected to the P system. The wheel cylinder W/C (RL) for the rear left wheel RL and the wheel cylinder W/C (FR) for the front right wheel FR are connected to the S system. Further, oil pumps (pumps) PP and PS are provided in the P system and the S system, respectively. The oil pumps PP and PS are drive by one motor M. The motor M is a rotary electric motor. The motor M is, for example, a brushed motor. The oil pumps PP and PS are, for example, plunger pumps.

Fluid passages 1 and fluid passages 2, which connect the master cylinder M/C and the wheel cylinders W/C to each other, are provided in the hydraulic unit HU. A fluid passage 2S branches into fluid passages 2RL and 2FR, and the fluid passages 2RL and 2FR are connected to the wheel cylinders W/C (RL) and W/C (FR), respectively. A fluid passage 2P branches into fluid passages 2FL and 2RR, and the fluid passages 2FL and 2RR are connected to the wheel cylinders W/C (FL) and W/C (RR), respectively. Gate-out valves (hereinafter referred to as G/V-OUTs) 3, which are normally-opened electromagnetic valves, are provided in the fluid passages 1. The master cylinder hydraulic pressure sensor 103 is provided at a position on a master cylinder side with respect to the G/V-OUT 3P in the fluid passage 1P of the P system. Fluid passages 4 are provided in the fluid passages 1 in parallel with the G/V-OUTs 3. Check valves 5 are provided in the fluid passages 4. Each of the check valves 5 permits the brake fluid to flow from the master cylinder M/C to the wheel cylinders W/C but prohibits the brake fluid from flowing in an opposite direction. Solenoid IN valves (hereinafter referred to as Sol/V-INs) 6, which are normally-opened electromagnetic valves corresponding to the individual wheel cylinders W/C, are provided in the fluid passages 2. Fluid passages 7 are provided in the fluid passages 2 in parallel with the Sol/V-INs 6. Check valves 8 are provided in the fluid passages 7. Each of the check valves 8 permits the brake fluid to flow from the wheel cylinder W/C to the master cylinder M/C but prohibits the brake fluid from flowing in an opposite direction.

Discharge sides of the oil pumps P, and the fluid passages 2 are connected to each other via fluid passages 9. Discharge valves 10 are provided in the fluid passages 9. Each of the discharge valves 10 permits the brake fluid to flow from the oil pump P toward the fluid passage 2 but prohibits the brake fluid from flowing in an opposite direction. Positions in the fluid passages 1 on the master cylinder side with respect to the G/V-OUTs 3, and intake sides of the oil pumps P are connected to each other via the fluid passages 11 and the fluid passages 12. Pressure adjustment reservoirs 13 are provided between the fluid passages 11 and the fluid passages 12. Positions in the fluid passages 2 on the wheel cylinder side with respect to the Sol/V-INs 6, and the pressure adjustment reservoirs 13 are connected to each other via fluid passages 14. The fluid passages 14S and 14P branch into fluid passages 14RL and 14FR, and fluid passages 14FL and 14RR, respectively, and then are connected to the corresponding wheel cylinders W/C. Solenoid OUT valves (hereinafter referred to as Sol/V-OUTs) 15, which are normally-closed electromagnetic valves, are provided in the fluid passages 14. The pressure adjustment reservoirs 13 each include a reservoir piston 13a, a reservoir spring 13b, and a check valve 16. The reservoir piston 13a is provided so as to be able to carry out a vertical stroke in the reservoir. The reservoir piston 13a is lowered and raised according to an increase and a reduction in a brake fluid amount flowing into the reservoir, respectively. The reservoir spring 13b biases the reservoir piston 13a in an upward direction. The check valve 16 includes a ball valve 16a and a valve seat 16b. The ball valve 16a is provided integrally with the reservoir piston 13a, and is vertically moved according to the stroke of the reservoir piston 13a. The ball valve 16a is biased by a not-illustrated valve spring in a downward direction. An elastic force of the valve spring is set to a weaker force than an elastic force of the reservoir spring 13b. The valve seat 16b abuts against the ball valve 16a when the ball valve 16a is lowered.

The reservoir piston 13a is lowered against the biasing force of the reservoir spring 13b when the brake fluid flows in from the fluid passage 14. As a result, the brake fluid flows into the reservoir. The brake fluid flowing into the reservoir is supplied to the intake side of the oil pump P via the fluid passage 12. At this time, the ball valve 16a is also lowered according to the decent of the reservoir piston 13a, and is seated on (abuts against) the valve seat 16b due to the biasing force of the valve spring. As a result, the check valve 16 is brought into a closed state. Therefore, if the brake fluid flows into the pressure adjustment reservoir 13 by a larger amount than an intake capability of the oil pump P when the oil pump P is actuated, the check valve 16 is brought into the closed state and the brake fluid stops flowing in from the master cylinder side to the pressure adjustment reservoir 13. On the other hand, if the brake fluid flows into the pressure adjustment reservoir 13 by a smaller amount than the intake capability of the oil pump P when the oil pump P is actuated, a pressure in the fluid passage 12 reduces and therefore the reservoir piston 13a is raised. At this time, the ball valve 16a is also raised to be separated from the valve seat 16b according to the ascent of the reservoir piston 13a. As a result, the check valve 16 is brought into an opened state. Therefore, communication is established between the master cylinder side and the intake side of the oil pump P, so that the brake fluid flows in from the master cylinder side to the pressure adjustment reservoir 13. The check valve 16 is brought into the closed state when the fluid passage 11 has a high inner pressure exceeding a predetermined pressure, such as when the driver presses the brake pedal BP. Due to this configuration, the brake fluid does not flow from the master cylinder side to the pressure adjustment reservoir 13, and therefore the intake side of the oil pump P can be prevented from being subjected to the high pressure.

The brake control unit BRKCU performs anti-lock brake (ABS) control as brake control. The ABS control is control of, upon detecting that a wheel has a lock tendency while the driver operates the brake, repeatedly reducing, maintaining, and increasing the wheel cylinder hydraulic pressure so as to generate a maximum braking force for this wheel while preventing the lock. At the time of the ABS pressure reduction control, the brake control unit BRKCU reduces the wheel cylinder hydraulic pressure by closing the Sol/V-IN 6 and opening the Sol/V-OUT 15 from the state illustrated in FIG. 2 (a state in which no power is supplied to each of the valves) to thus release the brake fluid in the wheel cylinder W/C to the pressure adjustment reservoir 13. In the ABS maintaining control, the brake control unit BRKCU maintains the wheel cylinder hydraulic pressure by closing both the Sol/V-IN 6 and the Sol/V-OUT 15. In the ABS pressure increase control, the brake control unit BRKCU increases the wheel cylinder hydraulic pressure by controlling the Sol/V-IN 6 in a valve-opening direction and closing the Sol/V-OUT 15 to thus supply the brake fluid from the master cylinder M/C to the wheel cylinder W/C.

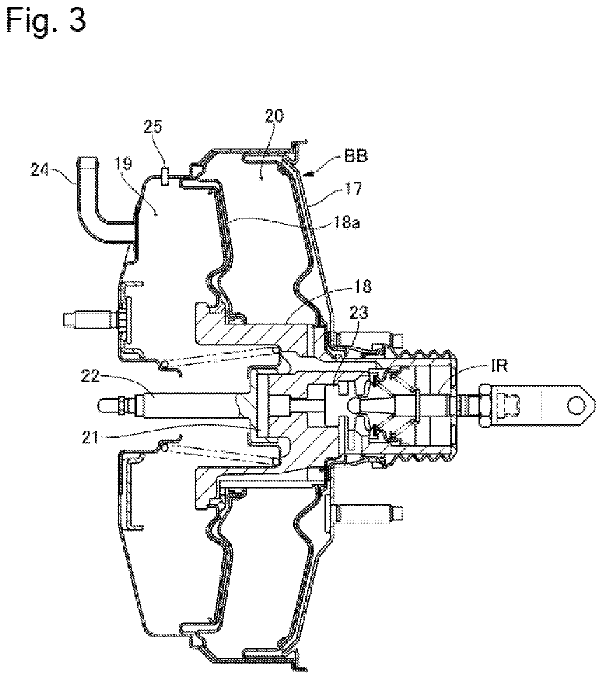

Further, the brake control unit BRKCU can perform automatic brake control such as electronic stability control, adaptive cruise control, and brake assist control by actuating each of the valves and the oil pumps P as the brake control. The electronic stability control is control of achieving stabilization of a behavior of the vehicle by controlling the wheel cylinder hydraulic pressure of a predetermined control target wheel upon detecting that an oversteer tendency or an understeer tendency increases while the vehicle is turning. The adaptive cruise control is control of automatically generating the braking force according to a relative relationship to a preceding vehicle by automatic cruise control. The brake assist control is control of generating, in the wheel cylinder W/C, a higher pressure than the pressure actually generated in the master cylinder M/C when the driver operates the brake. If a pressure in a negative pressure chamber 19 (refer to FIG. 3) of the brake booster BB that is detected by a negative pressure sensor 25 is higher than a threshold value, the brake control unit BRKCU determines that the brake booster BB reaches an assist limit, and carries out an active pressure increase of securing the required wheel cylinder hydraulic pressure by actuating the oil pumps P.

FIG. 3 is a vertical cross-sectional view of the brake booster BB.

The brake booster BB includes a hollow housing 17 and a power piston 18 provided in the housing 17. The power piston 18 includes a diagram 18a, and divides an inside of the housing 17 into a negative pressure chamber 19 on the master cylinder M/C side, and a variable pressure chamber 20 on the brake pedal BP side. The negative pressure sensor 25 is provided at a position of the housing 17 which position faces the negative pressure chamber 19. The power piston 18 is connected to the brake pedal BP via the input rod IR on the brake pedal BP side, and is connected to a booster piston rod 22 via a rubber reaction disk 21 on the master cylinder M/C side. The booster piston 22 is connected to a pressure application piston (not illustrated) of the master cylinder M/C, and transmits an actuation force of the power piston 18 to the pressure application piston. A valve mechanism 23 is provided between the negative pressure chamber 19 and the variable pressure chamber 20. The valve mechanism 23 is actuated according to a relative movement between the input rod IR and the power piston 18. A negative pressure introduction pipe 24 is connected to the negative pressure chamber 19. The negative pressure introduction pipe 24 introduces the negative pressure generated in an intake manifold when the engine ENG is actuated, into the negative pressure chamber 19.

In the brake booster BB, the variable pressure chamber 20 is brought out of communication with the atmosphere and into communication with the negative pressure chamber 19 by the valve mechanism 23, when the brake booster BB is not actuated. In this state, pressures equal to each other (pressures equal to or lower than the atmospheric pressure) are maintained in both the negative pressure chamber 19 and the variable pressure chamber 20. On the other hand, when the brake booster BB is actuated, approach of the input rod IR to the power piston 18 brings the variable pressure chamber 20 out of communication with the negative pressure chamber 19 and into communication with the atmosphere by the valve mechanism 23. In this state, the pressure in the variable pressure chamber 20 increases closer to the atmospheric pressure and generates a differential pressure between the negative pressure chamber 19 and the variable pressure chamber 20. This differential pressure causes the power piston 18 to move forward, thereby causing the hydraulic pressure to be generated in the master cylinder M/C according to the brake operation force boosted by the brake booster BB. A volume in the negative pressure chamber 19 reduces according to the forward movement of the power piston 18, and therefore the pressure in the negative pressure 19 increases closer to the atmospheric pressure. Disappearance of the differential pressure between these chambers 19 and 20 causes the brake booster BB to reach a full load point (an assist limit point) at which the assist force of the brake booster BB cannot be acquired any longer.

When the brake booster BB reaches the full load point, the brake control unit BRKCU starts the active pressure increase by actuating the oil pumps P. At this time, a failure in the negative pressure sensor 25, if any, makes it impossible to determine whether the brake booster BB reaches the full load point, thereby making it impossible to perform an appropriate active pressure increase. Therefore, the brake control unit BRKCU according to the first embodiment determines the failure in the negative pressure sensor 25 based on a detection signal of the negative pressure sensor 25, and lights up a warning lamp on a dash board as a warning if determining that the failure has occurred in the negative pressure sensor 25. The warning may be issued with use of a warning report, a sound, and/or the like. The brake control unit BRKCU includes a failure diagnosis apparatus 27, which diagnoses the failure in the negative pressure sensor 25. The failure diagnosis apparatus 27 includes a negative pressure sensor signal input reception portion 27a, a brake release determination portion 27b, an abnormality diagnosis permission portion 27c, a change amount monitoring portion 27d, and an abnormality determination portion 27e. The negative pressure signal input reception portion 27a receives an input of the detection signal of the negative pressure sensor 25. The brake release determination portion 27b determines a release of the brake pedal BP by the driver (a brake release). The abnormality diagnosis permission portion 27c permits or prohibits execution of the diagnosis of the failure in the negative pressure sensor 25 based on the master cylinder hydraulic pressure or the like when the brake release determination portion 27b determines that the brake is released. The change amount monitoring portion 27d monitors a change amount of the detection signal of the negative pressure sensor 25 according to the brake release. The abnormality determination portion 27e determines that the negative pressure sensor 25 is abnormal if the monitored change amount is a predetermined change amount or smaller.

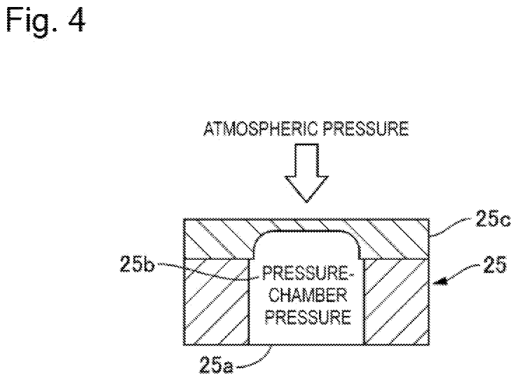

FIG. 4 is a schematic view of main portions of the negative pressure sensor 25.

The negative pressure sensor 25 is a thin-film type pressure sensor using a diaphragm. The negative pressure sensor 25 includes a negative pressure introduction port 25a, a pressure chamber 25b, and a diaphragm 25c. The negative pressure introduction port 25a is opened to the negative pressure chamber 19 in the brake booster BB, and the diaphragm 25c is located outside the housing 17 of the brake booster BB. The pressure in the negative pressure chamber 19 is introduced into the pressure chamber 25b via the negative pressure introduction port 25a. The diaphragm 25c is made of metal, and is elastically deformed due to the differential pressure between the pressure in the negative pressure chamber 19 (a pressure-chamber pressure) and the atmospheric pressure. The negative pressure sensor 25 detects the pressure in the negative pressure chamber 19 based on a change in electric resistance that is generated due to a distortion of a metallic gage thin film (not illustrated) formed on the diaphragm 25c.

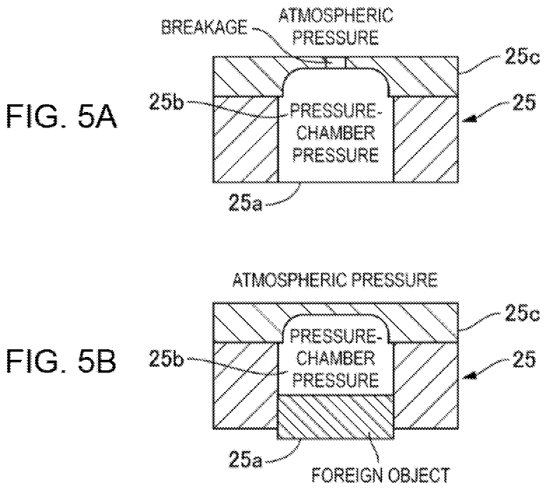

FIG. 5 illustrates an example of a stuck failure in the negative pressure sensor 25. FIG. 5(a) illustrates an example of a failure in the negative pressure sensor 25 due to breakage of the diaphragm 25c. When the diaphragm 25c is broken, the pressure-chamber pressure is constantly kept at the atmospheric pressure, which makes it impossible to detect the pressure in the negative pressure chamber 19. FIG. 5(b) illustrates an example of a failure in the negative pressure sensor 25 due to clogging of the negative pressure introduction port 25a. When the negative pressure introduction port 25a is clogged by a foreign object, the pressure-chamber pressure is kept constant, which makes it impossible to detect the pressure in the negative pressure chamber 19.

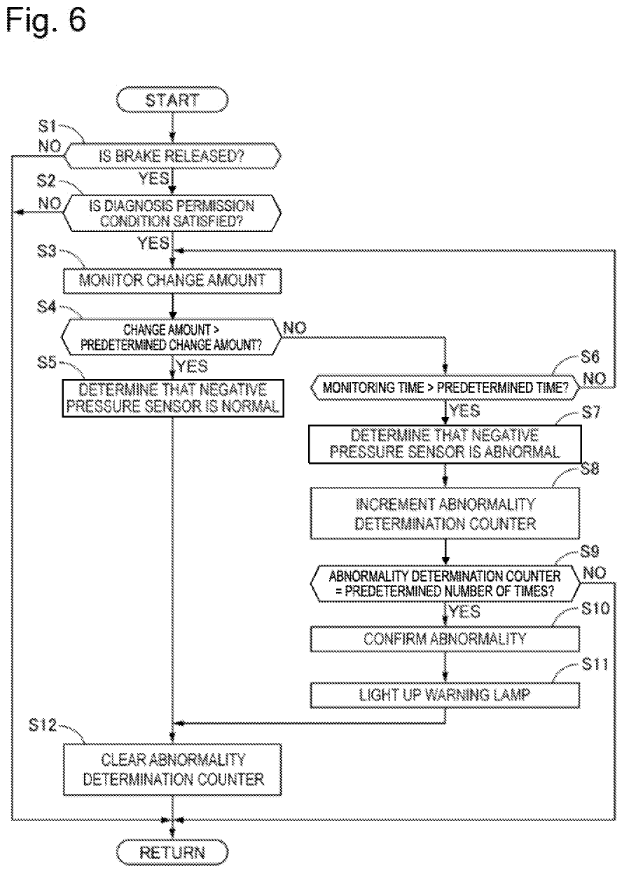

FIG. 6 is a flowchart illustrating a flow of processing for diagnosing the failure in the negative pressure sensor by the failure diagnosis apparatus 27 according to the first embodiment. This processing is repeated per a predetermined sampling period.

In step S1, the brake release determination portion 27b determines whether the brake is released (determining the brake release). If the determination in step S1 is YES, the processing proceeds to step S2. If the determination in step S1 is NO, the processing proceeds to RETURN. In this step, the brake release determination portion 27b calculates a decremental gradient of the master cylinder hydraulic pressure from a speed of a change in the detection signal of the master cylinder hydraulic sensor 103, and determines that the brake is released if the decremental gradient of the pressure is a predetermined gradient or higher.

In step S2, the abnormality diagnosis permission portion 27c determines whether a condition for permitting the diagnosis of the failure in the negative pressure sensor 25 is satisfied (permitting the diagnosis of the abnormality). If the determination in step S2 is YES, the processing proceeds to step S3. If the determination in step S2 is NO, the processing proceeds to RETURN. The failure diagnosis permission condition is satisfied when both the following two conditions are satisfied.

1. The master cylinder hydraulic pressure is a predetermined pressure or higher when an operation of returning the brake pedal is started.
2. The pressure (the negative pressure) in the negative pressure chamber 19 is not around the atmospheric pressure.

In step S3, the negative pressure sensor signal input reception portion 27a receives the input of the detection signal of the negative pressure sensor 25, and the change amount monitoring portion 27d monitors the change amount (a maximum value−a minimum value) of the detection signal of the negative pressure sensor 25 (monitoring the change amount).

In step S4, the abnormality determination portion 27e determines whether the change amount monitored in step S3 exceeds a predetermined change amount. If the determination in step S4 is YES, the processing proceeds to step S5. If the determination in step S4 is NO, the processing proceeds to step S6. The predetermined change amount is a value smaller than a change amount of the detection signal of the negative pressure sensor 25 that is monitored when the brake is released from such a state that the master cylinder hydraulic pressure reaches a predetermined pressure by the brake operation not exceeding the full load point when the negative pressure sensor 25 is normal. The predetermined change amount is a monitored value when a vehicle experiment is conducted in advance.

In step S5, the abnormality determination portion 27e determines that the negative pressure sensor 25 is normal.

In step S6, the abnormality determination portion 27e determines whether the change amount of the negative pressure is monitored for a predetermined time or longer. If the determination in step S6 is YES, the processing proceeds to step S7. If the determination in step S6 is NO, the processing proceeds to step S3. The predetermined time is a time during which the detection signal of the negative pressure sensor 25 can be expected to change. It is desirable to monitor the change in the detection signal of the negative pressure sensor 25 as long as possible to reduce a risk of incorrect detection, but it is meaningless to monitor it for too long because the pressure in the negative pressure chamber 19 would recover after reducing first. Therefore, the change can be expected to be sufficiently monitored by setting approximately one second as the predetermined time.

In step S7, the abnormality determination portion 27e determines that the negative pressure sensor 25 is abnormal (determining the abnormality).

In step S8, the abnormality determination portion 27e increments an abnormality determination counter (+1).

In step S9, the abnormality determination portion 27e determines whether the abnormality determination counter is a predetermined number of times or more. If the determination in step S9 is YES, the processing proceeds to step S10. If the determination in step S9 is NO, the processing proceeds to RETURN. The predetermined number of times is a natural number of 1 or larger, and can be arbitrarily set.

In step S10, the abnormality determination portion 27e confirms the abnormality in the negative pressure sensor 25.

In step S11, the abnormality determination portion 27e lights up the warning lamp.

In step S12, the abnormality determination portion 27e clears the abnormality determination counter.

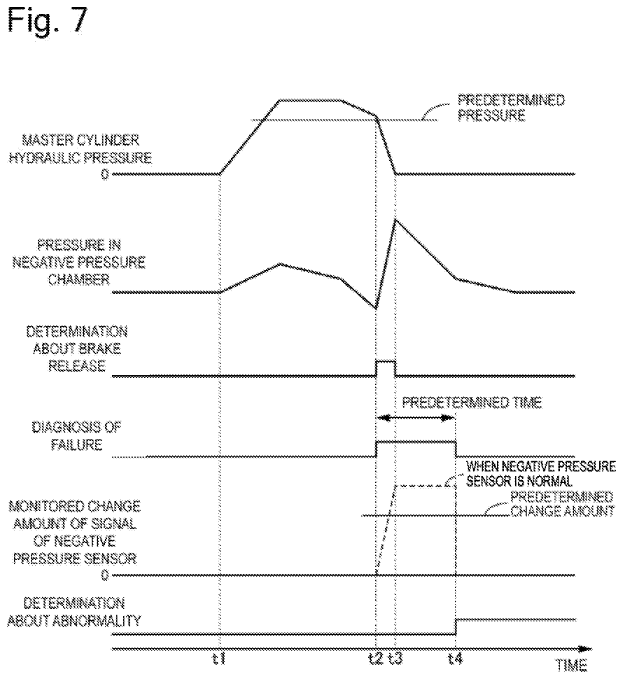

FIG. 7 is a timing chart indicating the function of diagnosing the failure in the negative pressure sensor according to the first embodiment. As an assumed situation here, assume that the stuck failure has occurred in the negative pressure sensor 25.

At time t1, the driver starts pressing the brake pedal BP.

At time t2, the pressure in the negative pressure chamber 19 suddenly increases because the driver releases the brake pedal BP. The failure diagnosis apparatus 27 determines that the brake is released, and the failure diagnosis permission condition is satisfied, so that the failure diagnosis apparatus 27 starts monitoring the change amount of the detection signal of the negative pressure sensor 25.

At time t3, the brake release is ended (the brake pedal BP is returned to an initial position), but the change amount is smaller than the predetermined change amount and the monitoring time does not reach the predetermined time, so that the failure diagnosis apparatus 27 continues monitoring the change amount.

At time t4, the monitoring time reaches the predetermined time without the change amount of the negative pressure exceeding the predetermined change amount, so that the failure diagnosis apparatus 27 determines that the negative pressure sensor 25 is abnormal.

In this manner, the abnormality determination portion 27e determines that the negative pressure sensor 25 is abnormal if the change amount of the detection signal of the negative pressure sensor 25 according to the brake release is the predetermined change amount or smaller. When the brake pedal BP is pressed, the pressure in the negative pressure chamber 19 of the brake booster BB is a negative pressure, and the pressure in the variable pressure chamber 20 is the atmospheric pressure. When the brake pedal BP is released, the communication between the negative pressure chamber 19 and the variable pressure chamber 20 is established and the atmospheric pressure flows from the variable pressure chamber 20 into the negative pressure chamber 19, so that the pressure in the negative pressure chamber 19 suddenly increases. At this time, if the negative pressure sensor 25 is normal, i.e., no stuck failure (the breakage of the diaphragm 25c or the clogging of the negative pressure introduction port 25a) has occurred, the change amount of the detection signal of the negative pressure sensor 25 follows the change in the pressure in the negative pressure chamber 19 to suddenly increase from time t2 and exceed the predetermined change amount within the predetermined time. On the other hand, if the stuck failure has occurred in the negative pressure sensor 25, the detection signal of the negative pressure sensor 25 does not follow the change in the pressure in the negative pressure chamber 19. In other words, in the first embodiment, the abnormality in the negative pressure sensor 25 is diagnosed based on whether the negative pressure sensor 25 keeps up with the change in the pressure in the negative pressure chamber 19 according to the brake release. Therefore, the present embodiment can prevent or cut down the reduction in the frequency at which the abnormality in the negative pressure sensor 25 is diagnosed compared to the conventional technique that diagnoses the abnormality in the negative pressure sensor only when the master cylinder hydraulic pressure reaches the pressure corresponding to the full load point of the brake booster.

The brake release determination portion 27b determines that the brake is released if the decremental gradient of the master cylinder hydraulic pressure is the predetermined gradient or higher when the brake pedal BP is returned after being pressed. Therefore, the failure diagnosis apparatus 27 can accurately determine the brake release, thereby reducing the risk of incorrect detection.

The abnormality determination portion 27e confirms the abnormality if the negative pressure sensor 25 is continuously determined to be abnormal the predetermined number of times. As a result, the failure diagnosis apparatus 27 can reduce the risk of incorrect detection due to sensor noise or the like.

In the first embodiment, the failure diagnosis apparatus 27 does not issue the warning while the brake pedal BP is pressed but issues the warning while or after the brake pedal BP is returned from this pressing when the failure has occurred in the negative pressure sensor 25. This allows the failure diagnosis apparatus 27 to diagnose the abnormality in the negative pressure sensor 25 based on the change amount of the detection signal of the negative pressure sensor 25 according to the brake release. Then, in the first embodiment, the failure diagnosis apparatus 27 lights up the warning lamp as the warning if the change amount of the detection signal of the negative pressure sensor 25 at the time of the brake release is smaller than the change amount of the detection signal when the negative pressure sensor 25 is normal. In other words, the failure diagnosis apparatus 27 determines that the negative pressure sensor 25 is abnormal if the change amount of the detection signal of the negative pressure sensor 25 is the predetermined change amount or smaller when the brake is released, and lights up the warning lamp if the abnormality is continuously determined the predetermined number of times. As a result, the failure diagnosis apparatus 27 can prevent or cut down the reduction in the frequency at which the abnormality of the negative pressure sensor 25 is diagnosed.

The abnormality diagnosis permission portion 27c permits the diagnosis of the abnormality in the negative pressure sensor 25 if the master cylinder hydraulic pressure is the predetermined hydraulic pressure or higher, and prohibits the diagnosis of the abnormality in the negative pressure sensor 25 if the master cylinder hydraulic pressure is lower than the predetermined hydraulic pressure (the failure diagnosis permission condition 1). If the pedal is operated by a small amount at the time of the brake release, the failure diagnosis apparatus 27 may be unable to monitor the sufficient change amount of the detection signal of the negative pressure sensor 25, thereby incorrectly detecting the failure. Therefore, the failure diagnosis apparatus 27 can reduce the risk of incorrect detection by permitting the diagnosis of the abnormality only when the pedal operation amount is large at the time of the brake release.

The abnormality diagnosis permission portion 27c permits the diagnosis of the failure in the negative pressure sensor 25 if the pressure in the negative pressure chamber 19 is not around the atmospheric pressure (the failure diagnosis permission condition 2). When a negative pressure failure has occurred in the brake booster BB (the pressure in the negative pressure chamber 19≈the pressure in the variable pressure chamber 20≈the atmospheric pressure), the pressure in the negative pressure chamber 19 is not changed at the time of the brake release, which raises a possibility of the incorrect detection of the failure. Further, it is preferable to detect the negative pressure failure separately from the failure in the negative pressure sensor 25. Therefore, the failure diagnosis apparatus 27 can reduce the risk of incorrect detection by prohibiting the diagnosis of the failure in the negative pressure sensor 25 when the negative pressure failure has occurred in the brake booster BB.

### Second Embodiment

A second embodiment has a basic configuration similar to the first embodiment, and therefore will be described focusing on only differences therefrom.

In a brake apparatus according to the second embodiment, a flowchart illustrated in FIG. 6 uses a different failure diagnosis permission condition in step S2 from the first embodiment. In the second embodiment, at least one of the following individual conditions is used together as necessary in addition to the two conditions described in the first embodiment as the failure diagnosis permission condition.

3. The number of rotations of the engine is a predetermined number of times or more.
4. The engine is not stalled.
5. The accelerator pedal is not operated.
6. The brake is not released immediately before this time.
7. No failure has occurred in the oil pumps P and the like, and the active pressure increase can be carried out.

When the brake booster BB exceeds the full load point, the piston stroke amount in the master cylinder M/C with respect to the master cylinder hydraulic pressure reduces compared to when the brake booster BB does not exceed the full load point, and therefore the change amount of the pressure in the negative pressure chamber 19 reduces. Therefore, when the brake is released after the brake operation exceeding the full load point is performed, this brake release increases a possibility that the change amount of the detection signal of the negative pressure sensor 25 at the time of the brake release matches or falls below the predetermined change amount even when the negative pressure sensor 25 is normal, i.e., increases the possibility that the failure in the negative pressure sensor 25 is incorrectly detected. Now, the brake booster BP may reach the full load point, for example, when a capability of generating the negative pressure is low (the number of rotations of the engine is small, the engine is stalled, or the throttle valve is opened), when the brake is released successively, and when the active pressure increase is not actuated due to a failure or the like. Therefore, it is desirable to prohibit the diagnosis of the failure in the negative pressure sensor 25 as necessary if there is the possibility that the brake booster BB reaches the full load point (if the failure diagnosis permission conditions 3 to 7 are not satisfied). The failure diagnosis apparatus 27 can reduce the risk of incorrect detection by prohibiting the diagnosis of the failure in the negative pressure sensor 25 if there is the possibility that the brake booster BB reaches the full load point.

### Third Embodiment

A third embodiment has a basic configuration similar to the first embodiment, and therefore will be described focusing on only differences therefrom.

When the brake is released successively, a brake apparatus according to the third embodiment totals the change amount of the detection signal of the negative pressure sensor 25 that is generated at the time of each brake release, and determines the abnormality in the negative pressure sensor 25 by comparing the totaled value with a predetermined change amount. As a result, the failure diagnosis apparatus 27 can reduce the risk of incorrect detection. Further, the failure diagnosis apparatus 27 can prevent or cut down the reduction in the frequency at which the abnormality of the negative pressure sensor 25 is diagnosed.

### Other Embodiments

Having described the embodiments for implementing the present invention, the specific configuration of the present invention is not limited to the configurations of the embodiments, and the present invention also includes a design modification and the like thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects.

In the first embodiment, the brake release is determined based on the decremental gradient of the pressure in the master cylinder M/C, but may be determined by calculating a decremental gradient of the pedal operation amount from a speed at which the detection signal of the stroke sensor 104 changes, and determining that the brake is released if the decremental gradient is a predetermined gradient or higher. Directly detecting the speed at which the pedal operation amount changes allows the brake release to be detected with improved accuracy.

Whether the failure diagnosis permission condition is satisfied may be determined after the brake release is determined.

The present application claims priority to Japanese Patent Application No. 2016-231715 filed on Nov. 29, 2016. The entire disclosure of Japanese Patent Application No. 2016-231715 filed on Nov. 29, 2016 including the specification, the claims, the drawings, and the abstract is incorporated herein by reference in its entirety.

### REFERENCE SIGN LIST

BB brake booster
BP brake pedal
BRKCU brake control unit (control unit)
FL to RR each wheel
HU hydraulic unit
M/C master cylinder
W/C wheel cylinder
19 negative pressure chamber
25 negative pressure sensor
25a negative pressure introduction port
25c diaphragm
27 failure diagnosis apparatus
27a negative pressure sensor signal input reception portion
27b brake release determination portion
27c abnormality diagnosis permission portion
27d change amount monitoring portion
27e abnormality determination portion

1. An apparatus for diagnosing a failure in a negative pressure sensor for detecting a pressure in a negative pressure chamber of a brake booster configured to boost an operation force on a brake pedal, the apparatus for diagnosing the failure in the negative pressure sensor comprising:
a change amount monitoring portion configured to monitor a change amount of a detection signal of the negative pressure sensor when the brake pedal is returned after being pressed; and
an abnormality determination portion configured to determine that the negative pressure sensor is abnormal if the change amount is a predetermined change amount or smaller.

2. The apparatus for diagnosing the failure in the negative pressure sensor according to claim 1, further comprising a brake release determination portion configured to determine that the brake pedal is returned after being pressed if a speed of a change in a pedal operation amount matches or exceeds a predetermined speed when the brake pedal is returned after being pressed.

3. The apparatus for diagnosing the failure in the negative pressure sensor according to claim 2, further comprising an abnormality diagnosis permission portion configured to permit an abnormality diagnosis by the abnormality determination portion if a hydraulic pressure in a master cylinder configured to generate the hydraulic pressure according to the operation force boosted by the brake booster is a predetermined hydraulic pressure or higher, and prohibit the abnormality diagnosis if the hydraulic pressure in the master cylinder is lower than the predetermined hydraulic pressure.

4. The apparatus for diagnosing the failure in the negative pressure sensor according to claim 2, further comprising an abnormality diagnosis permission portion configured to permit an abnormality diagnosis by the abnormality determination portion if there is no possibility that the brake booster reaches a full load point at which a boosting force of the brake booster is maximized, and prohibit the abnormality diagnosis if there is the possibility.

5. The apparatus for diagnosing the failure in the negative pressure sensor according to claim 1, wherein the abnormality determination portion confirms an abnormality if the negative pressure sensor is continuously determined to be abnormal a plurality of times.

6. An apparatus for diagnosing a failure in a negative pressure sensor configured to detect a pressure in a negative pressure chamber of a brake booster configured to boost an operation force on a brake pedal:
wherein the apparatus for diagnosing the failure in the negative pressure sensor does not issue a warning while the brake pedal is pressed, but issues the warning while or after the brake pedal is returned from the pressing, when the failure has occurred in the negative pressure sensor.

7. The apparatus for diagnosing the failure in the negative pressure sensor according to claim 6, wherein the apparatus issues the warning if a change amount of a detection signal of the negative pressure sensor when the brake pedal is returned after being pressed is smaller than a change amount when the negative pressure sensor is normal.

8. The apparatus for diagnosing the failure in the negative pressure sensor according to claim 7, wherein the change amount of the detection signal of the negative pressure sensor falls below the change amount when the negative pressure sensor is normal, if a diaphragm of the negative pressure sensor is broken or a negative pressure introduction port is clogged.

9. A method for diagnosing a failure in a negative pressure sensor configured to detect a pressure in a negative pressure chamber of a brake booster configured to boost an operation force on a brake pedal, the method comprising:
monitoring a change amount of a detection signal of the negative pressure sensor when the brake pedal is returned after being pressed; and
determining that the negative pressure sensor is abnormal if the change amount is a predetermined change amount or smaller.

10. The method for diagnosing the failure in the negative pressure sensor according to claim 9, further comprising determining that the brake pedal is returned after being pressed if a pedal operation amount due to the return of the pressed brake pedal reaches or exceeds a predetermined amount.

11. The method for diagnosing the failure in the negative pressure sensor according to claim 10, further comprising permitting an abnormality diagnosis by the determining of the abnormality if a hydraulic pressure in a master cylinder configured to generate the hydraulic pressure according to the operation force boosted by the brake booster is a predetermined hydraulic pressure or higher, and prohibiting the abnormality diagnosis if the hydraulic pressure in the master cylinder is lower than the predetermined hydraulic pressure.

12. A brake apparatus comprising:
a hydraulic unit provided between a master cylinder and a wheel cylinder and configured to generate a hydraulic pressure in the wheel cylinder, the master cylinder being configured to generate a hydraulic pressure according to an operation force boosted by a brake booster configured to boost the operation force on a brake pedal, the wheel cylinder being provided on each wheel; and
a control unit configured to control the hydraulic unit,
wherein the control unit includes
a negative pressure sensor signal input reception portion configured to receive an input of a detection signal of a negative pressure sensor configured to detect a pressure in a negative pressure chamber of the brake booster,
a change amount monitoring portion configured to monitor a change amount of the detection signal of the negative pressure sensor when the brake pedal is returned after being pressed, and
an abnormality determination portion configured to determine that the negative pressure sensor is abnormal if the change amount is a predetermined change amount or smaller.
